(19) United States
(12) Patent Application Publication
(10) Pub. No.: US 2005/0287941 A1
(43) Pub. Date: Dec. 29, 2005

(54) Hopper coin and disc feeders

(76) Inventors: Timothy William Hill, Lyth Hill (GB); Simon John Scott-Brown, Shropshire (GB)

Correspondence Address: WOMBLE CARLYLE SANDRIDGE & RICE, PLLC, P.O. BOX 7037, ATLANTA, GA, 30357-0037, US

(21) Appl. No.: 10/962,298

(22) Filed: Oct. 8, 2004

Related U.S. Application Data
(63) Continuation of application No. 10/956,642, filed on Oct. 1, 2004, now abandoned.
(60) Provisional application No. 60/553,152, filed on Mar. 15, 2004.

(30) Foreign Application Priority Data
Oct. 2, 2003 (GB) GB 0323033.1
Mar. 12, 2004 (GB) GB 0405562.0

(51) Int. Cl. G07D 3/00

(52) U.S. Cl. 453/10

(57) ABSTRACT

A hopper coin and disc feeder of the inclined disc type is provided with vacuum suction means to hold the coins on the margin of the disc, rather than the disc being provided with mechanical driving means, such as pockets or a high-friction peripheral band. The margin of the disc is provided with a series of circumferentially-spaced through-holes, and a vacuum manifold is arranged at the rear of the disc to connect the disc holes in an arcuate region of the path of the disc margin to vacuum, the arcuate region extending between the 5 o'clock and 12 o'clock positions of the disc in a direction of rotation, at which latter position the coins in single file are stripped from the disc by a belt conveying means. The vacuum manifold can be an arcuate chamber sealed to the disc by parallel sealing strips, or the manifold may be sealed by a single closed-loop seal that follows the disc margin, but crosses the path of the holes at the 5 o'clock and 12 o'clock positions.

### CROSS-REFERENCE TO RELATED APPLICATIONS

This application is a continuation of application Ser. No. 10/956,642, filed Oct. 1, 2004; which application claims the benefit of provisional application No. 60/553,152, filed Mar. 15, 2004, and which application also claims priority to British application no. GB0323033.1, filed Oct. 2, 2003, and British application no. GB0405562.0, filed Mar. 12, 2004.

### INCORPORATION BY REFERENCE

The specification of U.S. application Ser. No. 10/956,642, filed Oct. 1, 2004; provisional application No. 60/553,152, filed Mar. 15, 2004; British application no. GB0323033.1, filed Oct. 2, 2003; and British application no. GB0405562.0, filed Mar. 12, 2004 are incorporated herein in their entirety, by this reference.

### FIELD OF THE INVENTION

This invention relates to hopper coin and disc feeders of the inclined disc type, that is, of the type in which a coin feeding disc is inclined at an acute angle to the horizontal in use, and a hopper wall extending adjacent to at least the lower portion of the disc which in use defines with the disc a holding space for holding a plurality of coins prior to feeding of the coins by the disc to one or more coin outlets.

The term ‘coin’ will be used hereinafter to include a disc, a component of a composite coin, such as a ring or blank, or a bogus coin such as a washer or counterfeit coin.

### BACKGROUND OF THE INVENTION

Hopper feeders of the inclined disc type have been known for very many years. They are used for feeding coins in single file from a batch of coins, to enable the coins to be counted and/or sorted and/or dispensed.

Many different constructions of hopper coin feeder have been proposed. The coin feeding disc has often been provided with a series of recesses or spaced fingers to define pockets around the periphery of the disc in order to pick out coins one by one in the pockets from a batch of coins lying against the disc. When the disc is rotated the resulting agitation of the batch of coins lying in the holding space causes coins to fall into the pockets of the rotating disc.

We took the view that in order to be capable of feeding coins at very high speeds, and particularly mixed coins of different diameters, it is better to employ a disc without such pockets, the disc being provided at least around the margin thereof with a high friction surface, such as that provided by polyurethane. We found, however, that whilst such a hopper feeder can be made to work effectively whilst there are several coins still in the holding space ready to be carried out by the disc, the disc did not always pick out very quickly the last few remaining coins from the holding space.

In an attempt to improve picking out of the last few remaining coins we have sometimes employed a pressure pad for urging the coins against the margin of the disc. The pressure pad has been pivotally mounted and resiliently biased towards the disc or biased by gravity.

However, the use of a pressure pad can result in damage to the polyurethane disc surface by the coins.

### SUMMARIES OF THE INVENTION

According to the invention a hopper feeder of the inclined disc type comprises vacuum suction means which is so arranged as to hold coins against the margin of the disc over an arcuate portion of the rotational path of the disc.

The arcuate portion is preferably that portion of the path of the disc that precedes a coin take-off region, which is preferably towards the top of the disc path.

The disc margin is preferably provided with a plurality of circumferentially-spaced holes which open to the front face of the disc.

The holes may be arranged in various ways. For example, there may be a single row of holes at a particular radius of the disc, there may be a plurality of rows of holes at different radii, or there may be a distribution of holes within an annular band of the disc face.

The holes preferably extend through the thickness of the disc from the rear face thereof, and a stationary vacuum manifold is positioned behind the disc, the vacuum manifold being provided with a vacuum outlet that extends over an arcuate portion of the circumferential path of the disc margin, and communicates directly with those holes that are in register with the vacuum outlet.

In one form of the invention the vacuum manifold is of part-annular shape as viewed in the direction normal to the disc, and the opposite margins of the vacuum manifold outlet are sealed to the rear face of the disc by suitable sealing means in the form of one or more elongate sealing strips that are biased against the disc. The biasing means for each sealing strip preferably comprises a respective elongate energising means.

In one embodiment of the invention the outer wall of the manifold, that wall which is adjacent to the disc, comprises a substantially sector-shaped plate provided with an arcuate through-slot to provide said manifold outlet and, on the side of the plate that faces the rotating disc, the slot is bordered by said sealing strips which are located in part-annular grooves in the plate, that extend parallel to the annular slot.

A manifold chamber is preferably then defined against the rearwardly-facing side of said plate, preferably by a manifold closure plate, and by a manifold peripheral wall that extends around the periphery of the plate.

In one embodiment the manifold outlet extends through substantially a semi-circle, and the manifold plate is substantially semi-circular but with a cut-out provided for the disc drive shaft.

A much-preferred embodiment avoids some of the complexities of the afore-mentioned constructions that employ individual sealing strips along opposite margins of the manifold outlet, and in accordance with that embodiment, the manifold outlet is sealed by a closed-loop sealing strip which in said arcuate region extends circumferentially of the disc and radially outward of the holes in the disc face but is positioned radially inwards of said holes in the region of the margin that is not subject to vacuum. This enables the use of a single strip only, which may be arranged to extend for substantially 360° about the disc axis.

Other objects, features and advantages of the present invention will become apparent upon reading and understanding this specification, taken in conjunction with the accompanying drawings.

Coin and disc feeders of the inclined disc type and in accordance with the invention will now be described, by way of example only, with reference to the accompanying schematic drawings.

### BRIEF DESCRIPTION OF THE DRAWINGS

In the Drawings:

FIG. 1 is a side elevation of a feeder in accordance with the invention, with the outer margin of a part of the disc edge shown in section on the arcuate section line 1-1 of FIG. 2, to show the series of holes extending through the disc,

FIG. 2 is a view in the direction of the arrow A in FIG. 1 and showing a part of the margin of the disc and an example of a hole layout,

FIG. 3 is an enlarged radial cross-sectional view taken on the line 3-3 of FIG. 2 to show a preferred sealing arrangement for use with a manifold outlet of arcuate shape,

FIG. 4 is an exploded perspective view of the disc and manifold assembly looking from the front side of the components,

FIG. 5 is an exploded view similar to FIG. 4 but looking from the rear side of the components,

FIG. 6 is a partial enlarged plan view of the assembled manifold assembly of FIG. 4 showing the use of a seal stop block to terminate the ends of the sealing strips,

FIG. 7 is a partial perspective enlarged view of the assembled manifold assembly of FIG. 4, shown sectioned on the plane 7-7 of FIG. 6,

FIG. 8 is a view similar to FIG. 7 but showing a modified arrangement for terminating the ends of the sealing strips,

FIG. 9 is a schematic view, looking normally of the disc, of a modified manifold sealing structure in which a single sealing strip extends around the disc axis,

FIG. 10 is an enlarged partial section on the line 10-10 of FIG. 9 and showing the sealing strip positioned radially outwardly of the path of the disc holes, and

FIG. 11 is a view similar to FIG. 10 but taken on the line 11-11 of FIG. 9 where the sealing strip is positioned radially inwardly of the path of the disc holes.

### DESCRIPTION OF EMBODIMENTS OF THE INVENTION

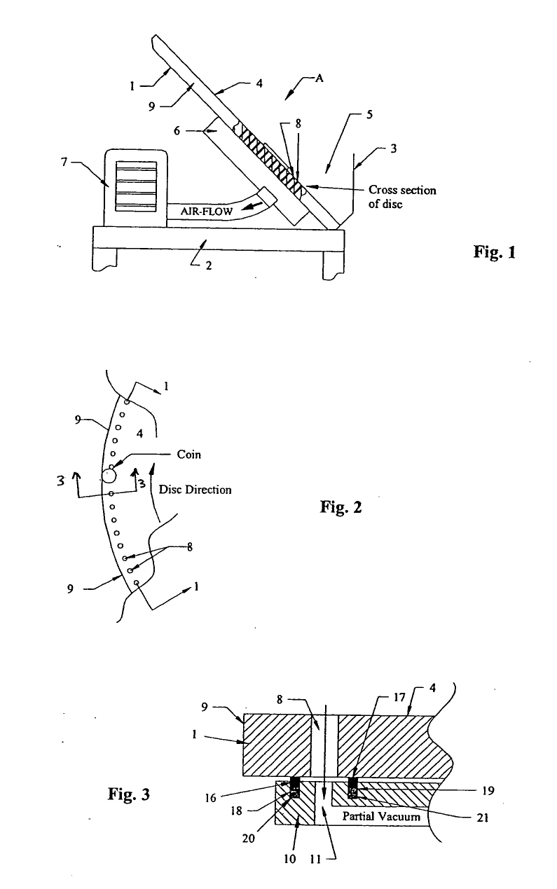

With reference to FIG. 1, a coin feeding disc 1 is mounted for rotation in well-known manner about the axis thereof with respect to a chassis in the form of a stationary base 2, and a hopper wall, indicated at 3, defines with the front, upwardly-facing face 4 of the disc a hopper 5 into which coins to be fed by the disc are directed by a coin supply, not shown. The base 2 stands in use on a horizontal surface, the disc 1 then being inclined at an acute angle to the horizontal.

A vacuum suction means for holding coins against the periphery of the disc is constituted by a vacuum manifold assembly 6, a vacuum source 7 and by a plurality of radially-spaced through-holes 8 in the disc, the holes 8 being spaced radially inwards from the radially outer edge 9 of the disc 1.

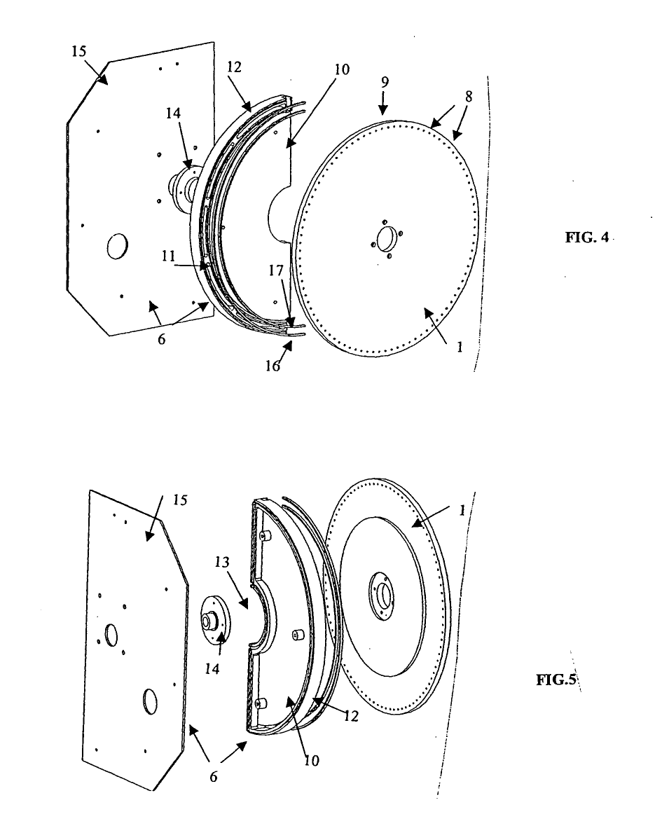

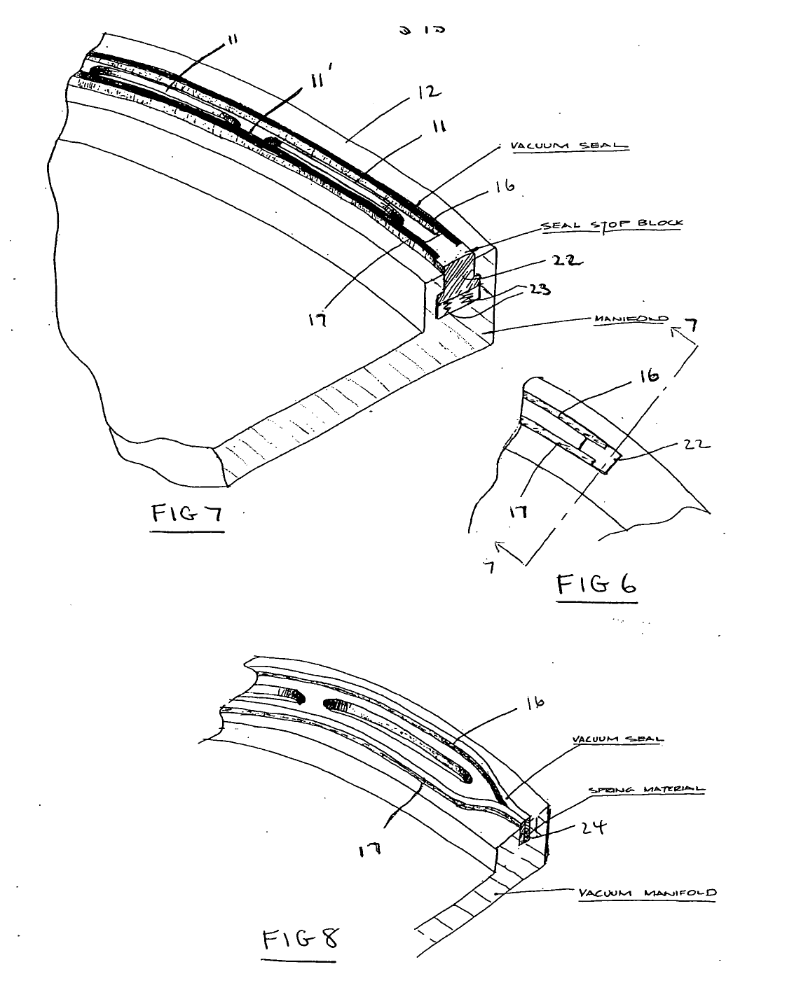

With reference to FIGS. 4 and 5, the manifold assembly is of generally sector shape as viewed in the axial direction of the disc, and comprises a substantially half-circular manifold front plate 10 which is provided adjacent to the radially outer margin thereof with a semi-circular through-slot 11, which is set at the same radius as the disc holes 8, so that the holes 8 are in register with the slot 11, as shown in FIG. 3, for approximately 180° of the rotational path of the disc. The slot 11 is interrupted by four bridges 11′ for strength.

The manifold further comprises a peripheral manifold wall 12 which extends around the entire periphery of the manifold front plate 10, and around a cut-out 13 which accommodates the disc drive shaft 14, the wall 12 projecting rearwardly from plate 10 for engagement with a rear manifold closure plate 15.

In order to provide a vacuum seal around the semi-circular slot 11, sealing strips 16, 17 are located in semi-circular slots 18, 19 respectively provided in the outer face of the front plate 10, and the sealing strips 16, 17 are energised by respective resilient strips 20, 21.

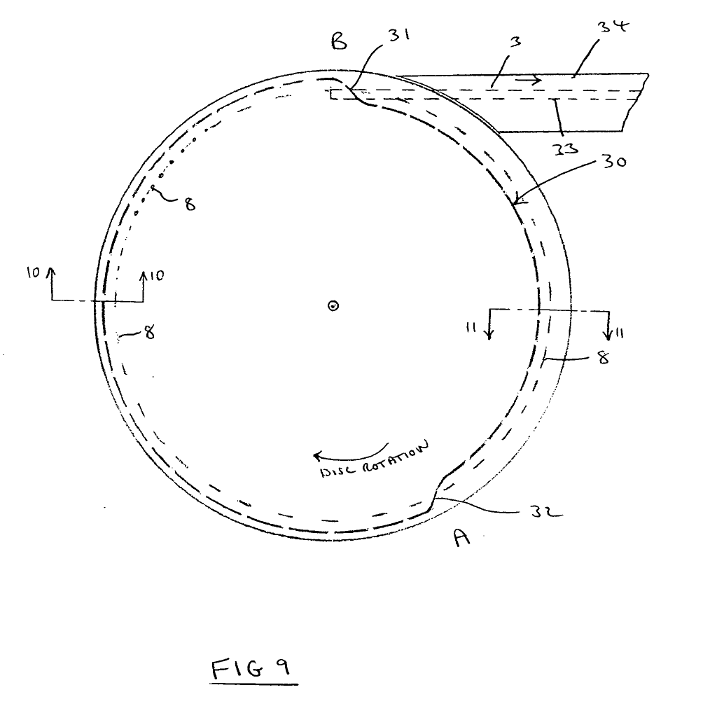

FIGS. 6 and 7 show one arrangement for terminating the sealing strips 16, 17 by the use of a seal stop block 22 which is of generally T-section, both in a radial plane of the manifold assembly 6, and as viewed normal to the manifold assembly 6. The stop block 22 is spring biased towards the disc by suitable resilient means 23, in order to close off the gap which would otherwise be present at the free ends of strips 16, 17. In the modification of FIG. 8, the requirement for a seal stop block is obviated by arranging for the ends of the slots that receive strips 16, 17 to be merged together into a common slot 24 in which the ends of the strips 16, 17 are in side-by-side engagement with one another. The slot 24 also contains suitable spring material for biasing the ends of the strips 16, 17 against the disc.

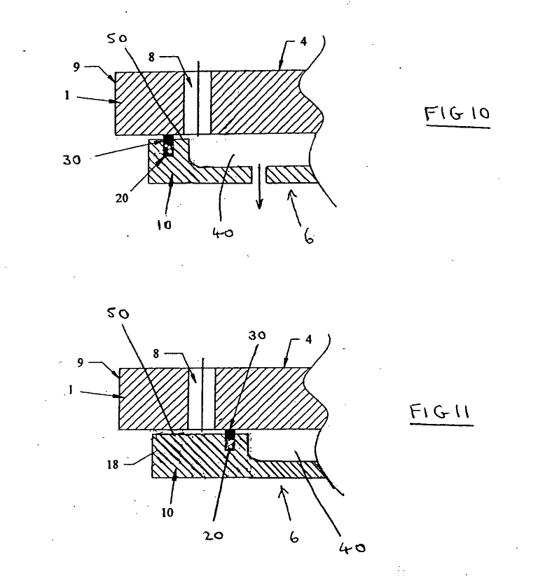

In the preferred embodiment of FIGS. 9 to 11 parts corresponding to those of the embodiment of FIGS. 1 to 3 have been given corresponding reference numerals. In FIGS. 9 to 11 a single closed-loop sealing strip 30 is employed, the sealing strip being located in a slot defined in a manifold back plate 10 which in this case can be in the form of a circular plate of similar radial dimensions to the disc, or the back plate can be an integral part of the machine chassis. In FIG. 9 the circular layout of the disc holes is indicated by a broken line 8.

As shown in FIGS. 10 and 11, the central regions of the plate 10, which is of shell shape, have been machined away to define an extensive vacuum chamber 40, surrounded by a land 50.

As can be seen in FIG. 9 the closed-loop seal 30, which protrudes from land 50, follows a circumferential arc between positions A and B, in the direction of rotation of the disc that is radially outside the line of holes 8, whereas in the circumferential arc between B and A the seal 30 is radially inside the arc of holes 8. The result of this is that the disc holes in the arc A to B are exposed to vacuum, as shown in FIG. 10, whereas those in the arc from B to A are not, as shown in FIG. 11.

As shown in FIG. 9, at A and B the seal 30 follows an angled path 31, 32 to make the transition between the two arcuate sections A to B and B to A of the seal path. The ends of the seal preferably substantially abut one another somewhere in the arc B to A, in the direction of rotation of the disc.

It should be appreciated that in the region between B and A, in the direction of disc rotation, the shape of the path of the seal does not need to be as shown, but could take an alternative path if desired.

The resilient biasing of the seal 30 in FIG. 9 can be as discussed in relation to the other embodiments. That is, it can comprise a co-extending closed-loop energising strip.

It will be appreciated that in the construction of FIG. 9 it is necessary to seal the disc drive shaft where it extends through the vacuum chamber 40.

In FIG. 9, B represents the top, or 12 o'clock position, of the inclined disc, and a coin conveying belt is indicated at 33, the belt 33 extending along a table 34 generally in the manner set forth in our prior Patent Specification No. EP 0269690B (=WO 8707742). The belt 33 removes coins in known manner from the margin of the disc at B.

Position A is desirably at approximately the 5 o'clock position of the disc rotation in order that the disc holes are subjected to vacuum before the 6 o'clock position. This has the advantage that the coins in this region are likely to be falling and do not therefore need to be accelerated so much on being gripped by the disc. This is also found to assist in picking up the last coin of a batch of coins that has been fed into the hopper.

An advantage of the invention is that the vacuum retention of the coins on the margin of the disc enables the use of a smooth metal disc face, rather than a disc face provided around the margin with a relatively high friction material such as polyurethane. We found that such a polyurethane layer tends to get damaged by coins as they are dragged from the disc by the conveying belt, partly due to the fact that the belt is generally run at a higher speed than the periphery of the disc. A smooth metal disc face should not suffer damage in the same way.

The vacuum suction features described herein can with advantage be used in conjunction with one or more of the other machine features described in the three co-pending Pat. Applications filed 12 Mar. 2004 in the name of Scan Coin Industries AB.

The various embodiments disclosed herein are provided for the purpose of explanation and example only, and are not intended to limit the scope of the appended claims. Those of ordinary skill in the art will recognize that certain variations and modifications can be made to the described embodiments without departing from the scope of the invention.

1. In a hopper coin and disc feeder comprising a chassis, a disc drive shaft rotatably mounted on said chassis, a coin feeding disc carried by said drive shaft whereby said disc is inclined at an acute angle to the horizontal in use, a hopper wall mounted on said chassis and extending adjacent to at least the lower portion of the upper face of said disc for defining with said upper face a holding space for a plurality of coins prior to feeding of said coins by said disc, a coin outlet positioned downstream of said holding space in the direction of rotation of the disc, and a coin take-off device carried by said chassis for removing at least some of the coins being conveyed in use by the disc and directing those coins to said coin outlet, the improvement comprising:
a vacuum source for producing a vacuum,
a vacuum manifold mounted on said chassis and having a manifold inlet connected to said vacuum source,
a manifold outlet shaped to extend over an arcuate portion of the rotational path of the annular margin of the disc, and
vacuum distributing channels provided in said disc margin for directing said vacuum at coins being carried round by said disc margin in said arcuate region of said disc path.

2. A hopper feeder as in claim 1 wherein said vacuum distributing channels are in the form of a plurality of circumferentially-spaced holes in said disc which open to said upper face of said disc.

3. A hopper feeder as in claim 2 wherein said disc holes open to said lower face of said disc.

4. A hopper feeder as in claim 3 wherein said manifold comprises first and second manifold outlet sealing strips that extend along said arcuate portion of said disc path, said first strip being positioned radially outside the path of said plurality of holes, and said second strip being positioned radially inwards of said path of said holes, and said feeder comprises spring biasing means for biasing said first and second strips against said lower face of said disc.

5. A hopper feeder as in claim 3 wherein said manifold outlet is sealed to said lower face of said disc by a single closed-loop seal, said seal comprising a radially outer seal portion and a radially inner seal portion, said radially outer seal portion extending along said arcuate region of said path of said disc margin and radially outwards of said holes, said radially inner seal portion extending radially inwards of said disc holes for the remainder of said path of said disc margin.

6. A hopper feeder as in claim 5 comprising seal biasing means for biasing said seal against said rear face of said disc, said seal biasing means comprising a closed-loop biasing strip that co-extends with said single closed-loop seal.

7. A hopper feeder as in claim 6 wherein said drive shaft extends through said vacuum manifold, and said sealing strip extends for substantially 360° about the axis of said drive shaft, and comprising a shaft sealing means for sealing said drive shaft against air flow past said shaft.

8. A hopper feeder as in claim 7 wherein said vacuum manifold comprises a shell body, said shell body having a periphery defining a land that extends around the margin of said disc and faces said lower face of said disc, said land being formed with a closed-loop recess in which said closed-loop seal is housed.
